(19) United States
(12) Patent Application Publication
(10) Pub. No.: US 2025/0368010 A1
(43) Pub. Date: Dec. 4, 2025

(54) ELECTRIC AIRFLOW DIRECTION CONTROL DEVICE

(71) Applicant: HYUNDAI MOBIS CO., LTD., Seoul (KR)

(72) Inventor: Won Sik KIM, Yongin-si (KR)

(73) Assignee: HYUNDAI MOBIS CO., LTD., Seoul (KR)

(21) Appl. No.: 19/010,745

(22) Filed: Jan. 6, 2025

(30) Foreign Application Priority Data
Jun. 4, 2024 (KR) 10-2024-0073322

(51) Int. Cl. B60H 1/34

(52) U.S. Cl. CPC B60H 1/3421; B60H 2001/3471

(57) ABSTRACT

An electric airflow direction control device including a duct part configured to guide air, an up-and-down control unit rotatably mounted to the duct part in an up-and-down direction and configured to control airflow in the up-and-down direction, a right-and-left control unit rotatably mounted to the duct part in a right-and-left direction and configured to control airflow in the right-and-left direction, and a drive unit connected to the up-and-down control unit and the right-and-left control unit and configured to selectively provide a rotational force to one of the up-and-down control unit and the right-and-left control unit.

### CROSS-REFERENCE TO RELATED APPLICATION

This application claims priority from and the benefit under 35 USC § 119 of Korean Patent Application No. 10-2024-0073322, filed on Jun. 4, 2024, in the Korean Intellectual Property Office, the entire disclosure of which is incorporated by reference for all purposes.

### BACKGROUND

### 1. Field

Exemplary embodiments according to the present disclosure relate to an electric airflow direction control device, and more particularly, to an electric airflow direction control device capable of controlling airflow in both the up-and-down and right-and-left directions using a single driving source.

### 2. Description of the Related Art

Air vents, typically installed on the front instrument panel of a vehicle's interior, are mainly used in cooling and heating systems to direct cool and hot airflow generated from an air conditioner or heater into the vehicle's interior. The air vents are installed at the end of an airflow duct facing the vehicle's interior.

At least one vane is positioned in the air vent. The vane is coupled to the housing of the air vent with a hinge and rotatably installed.

The vane is usually positioned on the inside of the air vent for aesthetic reasons. Therefore, a knob is installed on the vane, allowing a user to grasp and manipulate the knob by hand to rotate the vane. As the vane rotates, the direction of air discharge changes.

Conventionally, an actuator is used to electrically control the airflow direction of the air vent. Since separate actuators are installed for the right-left and up-down rotation of the vane, there is an issue that space is required to install two actuators for each air vent. Therefore, this issue requires improvement.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided an electric airflow direction control device including a duct part configured to guide air, an up-and-down control unit rotatably mounted to the duct part in an up-and-down direction and configured to control airflow in the up-and-down direction, a right-and-left control unit rotatably mounted to the duct part in a right-and-left direction and configured to control airflow in the right-and-left direction, and a drive unit connected to the up-and-down control unit and the right-and-left control unit and configured to selectively provide a rotational force to one of the up-and-down control unit and the right-and-left control unit.

The up-and-down control unit may include an up-and-down wing part having a first length defined in the right-and-left direction, an up-and-down shaft part formed on both sides of the up-and-down wing part and configured to be rotatably mounted to the duct part, and an up-and-down gear part connected to the up-and-down shaft part and connected to the drive unit, the up-and-down gear part being configured to transmit a rotational force.

The up-and-down control unit further may include an up-and-down linkage part linked with the up-and-down wing part, the up-and-down linkage part being configured to enable rotation.

The right-and-left control unit may include a right-and-left wing part having a second length defined in the up-and-down direction, a right-and-left shaft part formed on both sides of the right-and-left wing part and rotatably mounted to the duct part, and a right-and-left gear part connected to the right-and-left shaft part and connected to the drive unit and configured to transmit a rotational force.

The right-and-left control unit further may include a right-and-left linkage part linked with the right-and-left wing part, the right-and-left linkage part being configured to enable rotation.

The drive unit may include a power supply part configured to provide a rotational force in the up-and-down direction and the right-and-left direction, a power rotation part configured to rotate the up-and-down direction and the right-and-left direction by the power supply part, an up-and-down transmission part linked with the power rotation part and configured to rotate the up-and-down control unit only when the power rotation part rotates in one direction, and a right-and-left transmission part linked with the power rotation part and configured to rotate the right-and-left control unit only when the power rotation part rotates in a second direction opposite to the one direction.

The power supply part may include a motor part configured to be driven when power is applied, a motor shaft part configured to rotate in the up-and-down direction and the right-and-left direction by driving the motor part, and a motor gear part mounted to the motor shaft part and configured to engage with the power rotation part.

The power rotation part may include a rotation input part configured to engage with the power supply part to enable rotation, an up-and-down output part formed on one side of the rotation input part and configured to selectively engage with the up-and-down transmission part to transmit a rotational force in the one direction, and a right-and-left output part formed on an opposite side of the rotation input part and configured to selectively engage with the right-and-left transmission part to transmit a rotational force in the second direction.

The rotation input part may include an input shaft part, an input plate part configured to rotate, and the input shaft part passes through the input plate part, and an input gear part formed on an edge of the input plate part and configured to engage with the power supply part.

The up-and-down output part may include an up-and-down output rod part positioned on one side of the input plate part and configured to rotate within a limited rotation angle and an up-and-down output restoration part configured to provide a restoring force to the up-and-down output rod part.

The up-and-down output part may include an up-and-down output fixing part coupled to one of one side of the input plate part and an inner side of the input gear part and an up-and-down output extension part configured to extend from the up-and-down output fixing part and having a curved shape that allows a deformation and restoration in the one direction.

The right-and-left output part may include a right-and-left output body part positioned on an opposite side of the input plate part and a plurality of right-and-left output engagement parts configured to protrude in a circumferential direction of the right-and-left output body part.

Each up-and-down output part of a plurality of the up-and-down output parts may be spaced apart in a circumferential direction.

The up-and-down transmission part may include an up-and-down wheel part configured to rotate in a first direction by the power rotation part, an up-and-down link part including a first end connected to the up-and-down wheel part, and an up-and-down reciprocating part connected to a second end opposite to the first end of the up-and-down link part and configured to transmit a rotational force to the up-and-down control unit while moving reciprocally as the up-and-down wheel part rotates.

The right-and-left transmission part may include a right-and-left wheel part configured to rotate in the second direction by the power rotation part, a right-and-left gear part configured to engage with the right-and-left wheel part through a bevel gear mechanism to enable rotation, a right-and-left link part including a first end connected to the right-and-left gear part, and a right-and-left reciprocating part connected to a second end opposite to the first end of the right-and-left link part and configured to transmit a rotational force to the right-and-left control unit while moving reciprocally as the right-and-left wheel part rotates.

### BRIEF DESCRIPTION OF THE DRAWINGS

FIG. 1 is a view schematically showing an electric airflow direction control device according to an embodiment of the present disclosure.

FIG. 2 is a view schematically showing an up-and-down control unit according to an embodiment of the present disclosure.

FIG. 3 is a view schematically showing a right-and-left control unit according to an embodiment of the present disclosure.

FIG. 4 is a side view schematically showing a drive unit according to an embodiment of the present disclosure.

FIG. 5 is a plan view schematically showing a drive unit according to an embodiment of the present disclosure.

FIG. 6 is a view schematically showing a power supply part according to an embodiment of the present disclosure.

FIG. 7 is a front perspective view schematically showing a power rotation part according to an embodiment of the present disclosure.

FIG. 8 is a rear perspective view schematically showing a power rotation part according to an embodiment of the present disclosure.

FIG. 9 is a view schematically showing an up-and-down output part according to a first embodiment of the present disclosure.

FIG. 10 is a view schematically showing an up-and-down output part according to a second embodiment of the present disclosure.

FIG. 11 is a view schematically showing an up-and-down transmission part according to an embodiment of the present disclosure.

FIG. 12 is a view schematically showing an operation process of an up-and-down transmission part according to an embodiment of the present disclosure.

FIG. 13 is a view schematically showing a right-and-left transmission part according to an embodiment of the present disclosure.

FIG. 14 is a view schematically showing an operation process of a right-and-left transmission part according to an embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

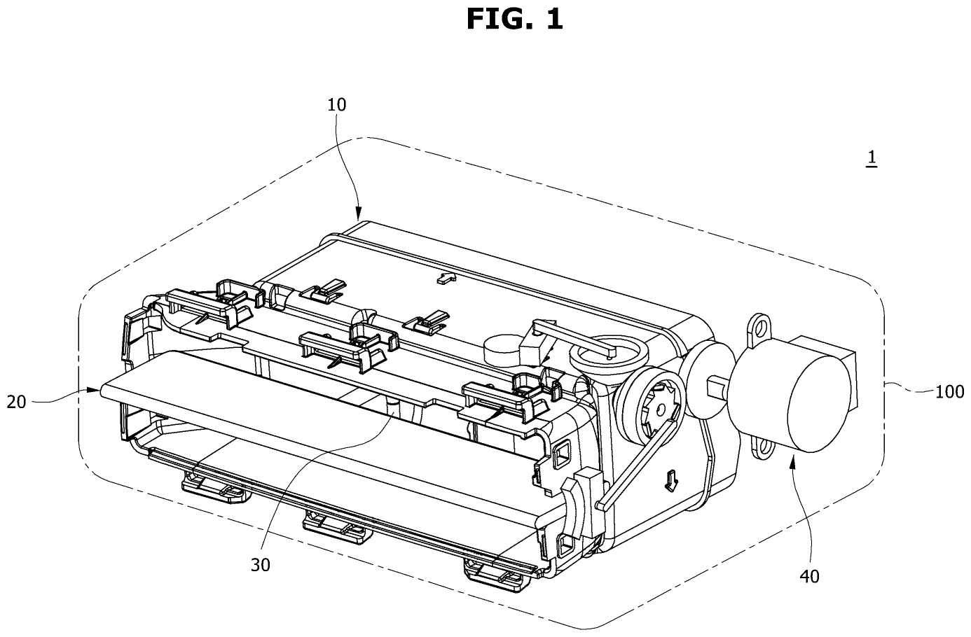

FIG. 1 is a view schematically showing an electric airflow direction control device according to an embodiment of the present disclosure. Referring to FIG. 1, an electric airflow direction control device 1 according to an embodiment of the present disclosure includes a duct part 10, an up-and-down control unit 20, a right-and-left control unit 30, and a drive unit 40.

The duct part 10 may guide air. For example, the duct part 10 may be mounted to a vehicle body and form a passage for airflow. The duct part 10 may be housed within a housing part 100. The housing part 100 may be fixedly installed on the vehicle body, and the duct part 10 housed within the housing part 100 may be modularized. In addition, the housing part 100 may be the vehicle body.

The up-and-down control unit 20 may be rotatably mounted to the duct part 10 in the up-and-down direction and control airflow in the up-and-down direction. For example, the up-and-down control unit 20 may be positioned in an outlet area of the duct part 10.

The right-and-left control unit 30 may be rotatably mounted to the duct part 10 in the right-and-left direction and control airflow in the right-and-left direction. For example, the right-and-left control unit 30 may be positioned behind the up-and-down control unit 20. Air may be discharged by sequentially passing through the right-and-left control unit 30 and the up-and-down control unit 20. The positions of the up-and-down control unit 20 and the right-and-left control unit 30 may be changed.

The drive unit 40 may be connected to the up-and-down control unit 20 and the right-and-left control unit 30, and selectively provide a rotational force to either the up-and-down control unit 20 or the right-and-left control unit 30. For example, when the drive unit 40 rotates clockwise, a rotational force may be transmitted to the up-and-down control unit 20, allowing the up-and-down control unit 20 to control airflow in the up-and-down direction. When the drive unit 40 rotates counterclockwise, a rotational force may be transmitted to the right-and-left control unit 30, allowing the right-and-left control unit 30 to control airflow in the right-and-left direction.

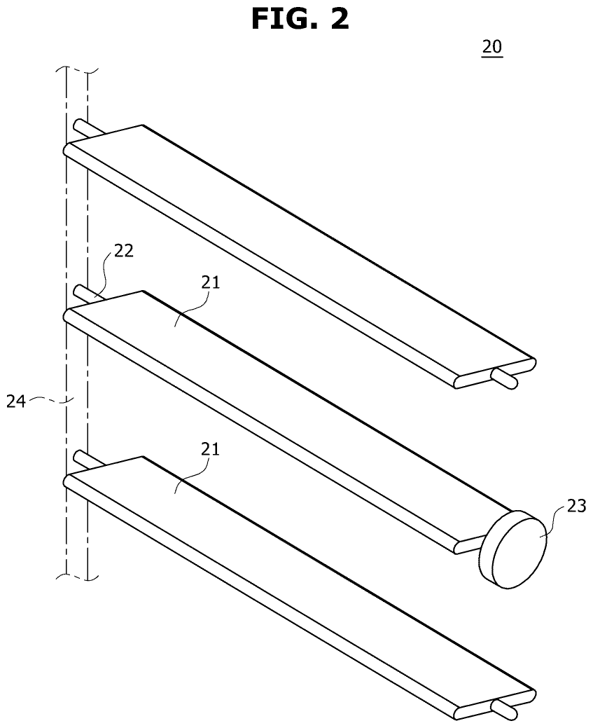

FIG. 2 is a view schematically showing an up-and-down control unit according to an embodiment of the present disclosure. Referring to FIG. 2, the up-and-down control unit 20 according to an embodiment of the present disclosure may include an up-and-down wing part 21, an up-and-down shaft part 22, and an up-and-down gear part 23.

The up-and-down wing part 21 may have a length in the right-and-left direction, and the up-and-down shaft part 22 may be formed on both sides of the up-and-down wing part 21. The up-and-down shaft part 22 may be rotatably mounted to the duct part 10. For example, the up-and-down shaft part 22, integrally formed with the up-and-down wing part 21, may be inserted into a hole formed in the duct part 10, allowing the up-and-down wing part 21 to rotate about the up-and-down shaft part 22 as the axis of rotation.

The up-and-down gear part 23 may be connected to the up-and-down shaft part 22 and connected to the drive unit 40 to transmit a rotational force. For example, the up-and-down gear part 23 may be coupled to one of the up-and-down shaft parts 22 and positioned between the duct part 10 and the housing part 100. The up-and-down gear part 23 may have a spur gear shape.

The up-and-down control unit 20 according to an embodiment of the present disclosure may further include an up-and-down linkage part 24. The up-and-down linkage part 24 may be linked with the up-and-down wing part 21 or the up-and-down shaft part 22 to enable rotation. For example, a plurality of up-and-down wing parts 21 may be positioned in the up-and-down direction and a rotational force of the up-and-down shaft part 22 may be transmitted to the other up-and-down wing parts 21 through the up-and-down linkage part 24. This up-and-down linkage part 24 may employ various methods of rotational force transmission.

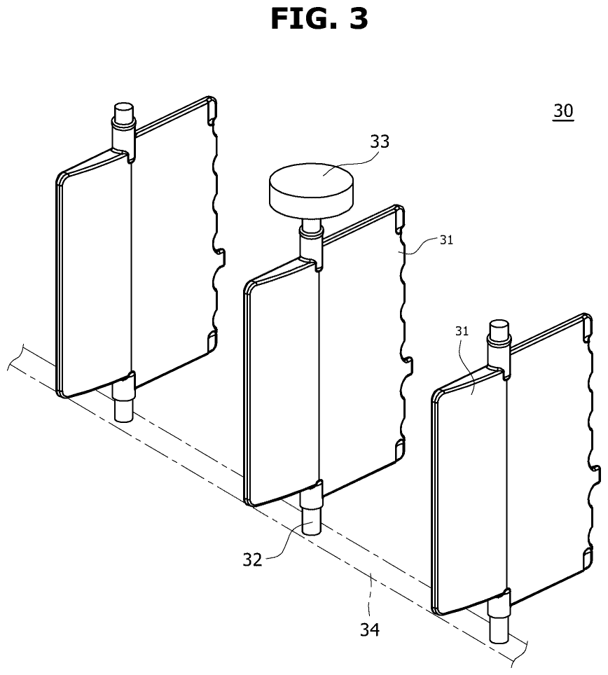

FIG. 3 is a view schematically showing a right-and-left control unit according to an embodiment of the present disclosure. A right-and-left control unit 30 according to an embodiment of the present disclosure may include a right-and-left wing part 31, a right-and-left shaft part 32, and a right-and-left gear part 33.

The right-and-left wing part 31 may have a length in the up-and-down direction, and the right-and-left shaft part 32 may be formed on the upper and lower sides of the right-and-left wing part 31. The right-and-left shaft part 32 may be rotatably mounted to the duct part 10. For example, the right-and-left shaft part 32, integrally formed with the right-and-left wing part 31, may be inserted into a hole formed in the duct part 10, allowing the right-and-left wing part 31 to rotate about the right-and-left shaft part 32 as the axis of rotation.

The right-and-left gear part 33 may be connected to the right-and-left shaft part 32 and connected to the drive unit 40 to transmit a rotational force. For example, the right-and-left gear part 33 may be coupled to one of the right-and-left shaft parts 32 and positioned between the duct part 10 and the housing part 100. The right-and-left gear part 33 may have a spur gear shape.

The right-and-left control unit 30 according to an embodiment of the present disclosure may further include a right-and-left linkage part 34. The right-and-left linkage part 34 may be linked with the right-and-left wing part 31 or the right-and-left shaft part 32 to enable rotation. For example, a plurality of right-and-left wing parts 31 may be positioned in the right-and-left direction and a rotational force of the right-and-left shaft part 32 may be transmitted to the other right-and-left wing parts 31 through the right-and-left linkage part 34. This right-and-left linkage part 34 may employ various methods of rotational force transmission.

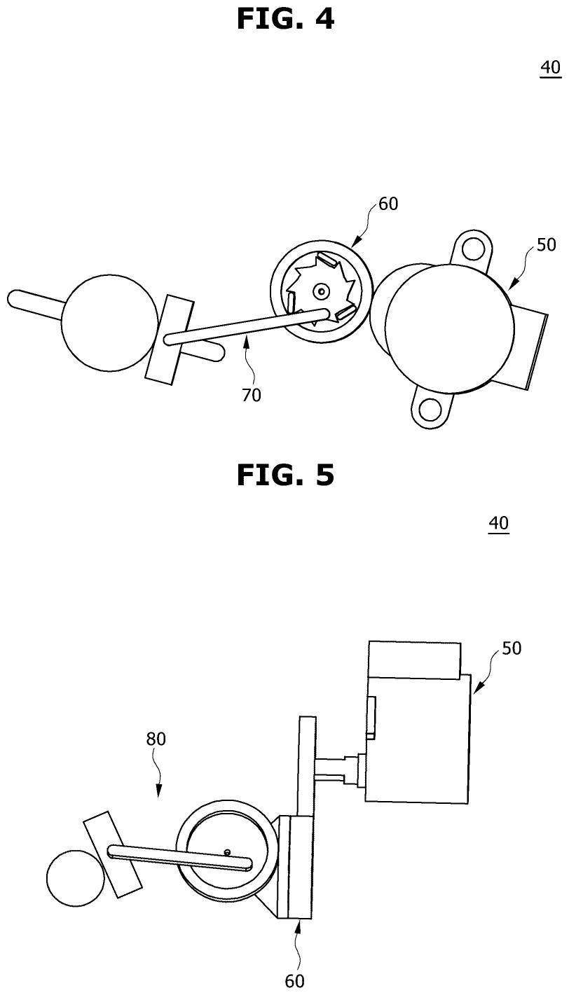

FIG. 4 is a side view schematically showing a drive unit according to an embodiment of the present disclosure. FIG. 5 is a plan view schematically showing a drive unit according to an embodiment of the present disclosure. Referring to FIGS. 4 and 5, a drive unit 40 according to an embodiment of the present disclosure may include a power supply part 50, a power rotation part 60, an up-and-down transmission part 70, and a right-and-left transmission part 80.

The power supply part 50 may provide a rotational force in both directions. For example, the power supply part 50 may rotate clockwise and counterclockwise.

The power rotation part 60 may rotate in both directions by the power supply part 50. For example, the power rotation part 60 may remain engaged with the power supply part 50. When the power supply part 50 rotates clockwise, the power rotation part 60 may rotate counterclockwise. When the power supply part 50 rotates counterclockwise, the power rotation part 60 may rotate clockwise.

The up-and-down transmission part 70 may be linked with the power rotation part 60 and rotate the up-and-down control unit 20 only when the power rotation part 60 rotates in one direction. For example, when the power rotation part 60 rotates clockwise, power may be transmitted to the up-and-down transmission part 70 to drive the up-and-down control unit 20. The up-and-down transmission part 70 may convert rotational motion into linear reciprocating motion, allowing the up-and-down control unit 20 to rotate in the up-and-down direction.

The right-and-left transmission part 80 may be linked with the power rotation part 60 and rotate the right-and-left control unit 30 only when the power rotation part 60 rotates in the opposite direction. For example, when the power rotation part 60 rotates counterclockwise, power may be transmitted to the right-and-left transmission part 80 to drive the right-and-left control unit 30. The right-and-left transmission part 80 may convert rotational motion into linear reciprocating motion, allowing the right-and-left control unit 30 to rotate in the right-and-left direction.

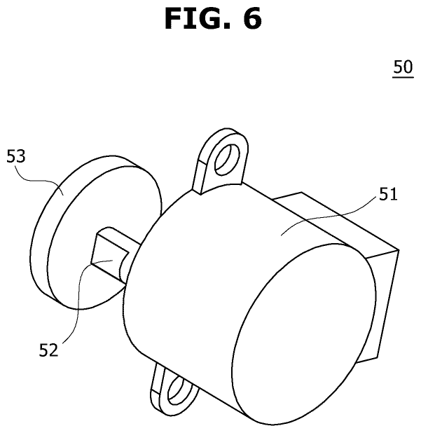

FIG. 6 is a view schematically showing a power supply part according to an embodiment of the present disclosure. Referring to FIG. 6, the power supply part 50 according to an embodiment of the present disclosure may include a motor part 51, a motor shaft part 52, and a motor gear part 53.

The motor part 51 may be driven when power is applied. For example, the motor part 51 may be mounted to the housing part 100.

The motor shaft part 52 may rotate in both directions by driving the motor part 51. For example, the motor shaft part 52 may be mounted to the motor part 51 and rotate clockwise or counterclockwise according to a drive signal of the motor part 51.

The motor gear part 53 may be mounted to the motor shaft part 52 and engage with the power rotation part 60. For example, the motor gear part 53 may be coupled to the motor shaft part 52 and linked with the motor shaft part 52. The motor gear part 53 may be a spur gear.

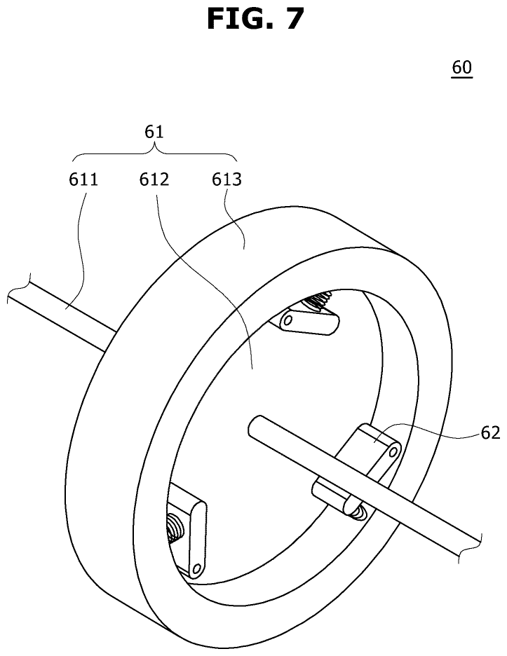

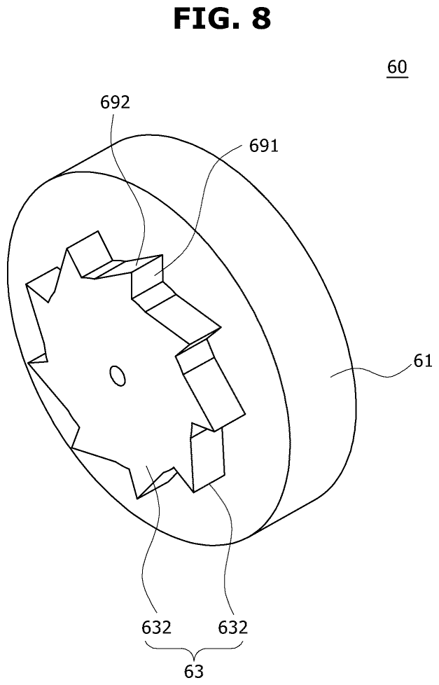

FIG. 7 is a front perspective view schematically showing a power rotation part according to an embodiment of the present disclosure. FIG. 8 is a rear perspective view schematically showing a power rotation part according to an embodiment of the present disclosure. Referring to FIGS. 7 and 8, the power rotation part 60 according to an embodiment of the present disclosure may include a rotation input part 61, an up-and-down output part 62, and a right-and-left output part 63.

The rotation input part 61 may engage with the power supply part 50 to enable rotation. For example, the rotation input part 61 may remain engaged with the motor gear part 53. The rotation input part 61 may be rotatably supported between the duct part 10 and the housing part 100.

The up-and-down output part 62 may be formed on one side of the rotation input part 61 and selectively engage with the up-and-down transmission part 70 to transmit a rotational force in one direction. For example, when the up-and-down output part 62 rotates clockwise, a rotational force may be transmitted to the up-and-down transmission part 70 to drive the up-and-down control unit 20. When the up-and-down output part 62 rotates counterclockwise, a rotational force may not be transmitted to the up-and-down transmission part 70 and maintain the state of the up-and-down control unit 20.

The right-and-left output part 63 may be formed on the opposite side of the rotation input part 61 and selectively engage with the right-and-left transmission part 80 to transmit a rotational force in the opposite direction. For example, the up-and-down output part 62 may be positioned on one side of the rotation input part 61, and the right-and-left output part 63 may be positioned on the opposite side of the rotation input part 61. Since the up-and-down output part 62 and the right-and-left output part 63 are positioned on each side of the rotation input part 61, a rotation direction may be opposite to each other depending on an observer's viewpoint. Therefore, the rotation direction will be described below based on the viewpoint of observing the up-and-down output part 62 from the outside. When the up-and-down output part 62 and the right-and-left output part 63 rotate clockwise, a rotational force may not be transmitted to the right-and-left transmission part 80 and maintain the state of the right-and-left control unit 30. When the up-and-down output part 62 and the right-and-left output part 63 rotate counterclockwise, the right-and-left output part 63 may engage with the right-and-left transmission part 80 to transmit a rotational force, thereby driving the right-and-left control unit 30.

The rotation input part 61 according to an embodiment of the present disclosure may include an input shaft part 611, an input plate part 612, and an input gear part 613.

The input shaft part 611 may have both ends supported on the duct part 10 and the housing part 100. For example, the input shaft part 611 may be fixed to the duct part 10 and the housing part 100 and have a cylindrical shape. In addition, the input shaft part 611 may be rotatably mounted to the duct part 10 and the housing part 100.

The input plate part 612, through which the input shaft part 611 passes, may rotate. For example, the input plate part 612 may have a disc shape. The input plate part 612 may have a hole formed at the center to allow the input shaft part 611 to pass through, and the input plate part 612 may rotate on the axis of the input shaft part 611. In addition, the input plate part 612 may be coupled to the input shaft part 611 that passes therethrough, and the input shaft part 611 may be rotatably mounted to the duct part 10 and the housing part 100.

The input gear part 613 may be formed on the edge of the input plate part 612 and engage with the power supply part 50. For example, the input gear part 613 may be formed on the rim of the input plate part 612. The input gear part 613 may have teeth formed along the outer circumferential surface and remain engaged with the motor gear part 53. The input gear part 613 may be formed thicker than the thickness of the input plate part 612. As a result, the front surface part of the input plate part 612 may be surrounded by the input gear part 613 to form an insertion space. The input plate part 612 and the input gear part 613 may be integrally formed.

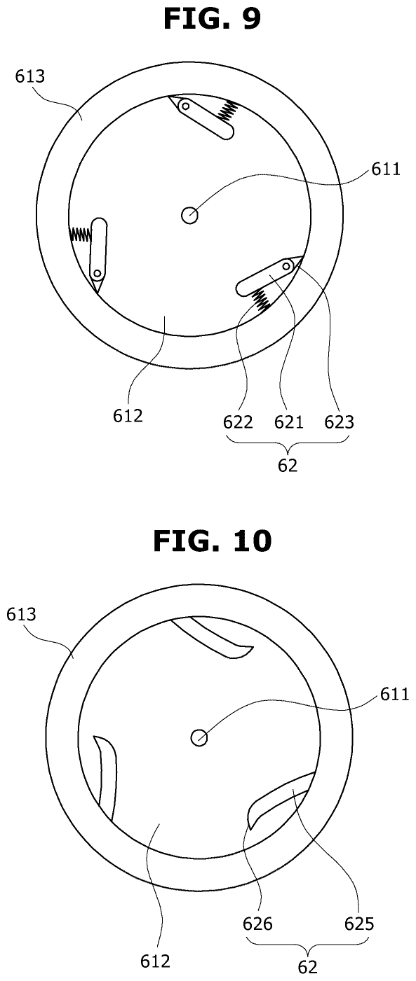

FIG. 9 is a view schematically showing an up-and-down output part according to a first embodiment of the present disclosure. Referring to FIG. 9, the up-and-down output part 62 according to the first embodiment of the present disclosure may include an up-and-down output rod part 621 and an up-and-down output restoration part 622.

The up-and-down output rod part 621 may be positioned on one side of the input plate part 612 and rotate within a limited rotation angle. For example, an end of the up-and-down output rod part 621 may be provided with a pin and rotatably mounted to the input plate part 612.

The up-and-down output restoration part 622 may provide a restoring force to the up-and-down output rod part 621. For example, the up-and-down output restoration part 622 may be a spring that connects the input gear part 613 and the opposite end of the up-and-down output rod part 621. The up-and-down output restoration part 622 may employ various restoration structures so that the opposite end of the up-and-down output rod part 621 moves toward the input gear part 613 due to an external force and then returns to the original position.

In addition, an up-and-down output stopper part 623 may be formed to protrude from the up-and-down output rod part 621 and brought close to the input gear part 613. When the up-and-down output stopper part 623 engages with the input gear part 613 due to an external force, the one-directional rotation of the up-and-down output rod part 621 may be restricted. The up-and-down output stopper part 623 may be formed to protrude from the input plate part 612 to limit a rotation angle of the up-and-down output rod part 621.

FIG. 10 is a view schematically showing an up-and-down output part according to a second embodiment of the present disclosure. The up-and-down output part 62 according to the second embodiment of the present disclosure may include an up-and-down output fixing part 625 and an up-and-down output extension part 626.

The up-and-down output fixing part 625 may be coupled to one side of the input plate part 612 or to the inner side of the input gear part 613. The up-and-down output extension part 626 may have a curved shape that allows deformation in one direction from the up-and-down output fixing part 625 and then restoration. The up-and-down output part 62 according to the second embodiment of the present disclosure may have an integrally formed up-and-down output fixing part 625 and up-and-down output extension part 626. The up-and-down output part 62 according to the second embodiment of the present disclosure may have a limited deformation angle for the up-and-down output fixing part 625 and the up-and-down output extension part 626. In other words, after being deformed by an external force in one direction, this up-and-down output part may return to the original position when the external force is removed. The up-and-down output part 62 according to the second embodiment of the present disclosure may support an external force in the opposite direction with the up-and-down output fixing part 625 and the up-and-down output extension part 626. In other words, the up-and-down output part 62 according to the second embodiment of the present disclosure may be deformed by an object providing an external force in one direction, thereby blocking power transmission, and remain engaged with an object providing an external force in the opposite direction, thereby enabling power transmission.

A plurality of up-and-down output parts 62 may be spaced apart in the circumferential direction. For example, the up-and-down output part 62 may be positioned inside the input gear part 613 and positioned in the circumferential direction of the input plate part 612. The up-and-down output part 62 may be positioned to be inclined in an area excluding the input shaft part 611.

Referring to FIG. 8, the right-and-left output part 63 may include a right-and-left output body part 631 and a right-and-left output engagement part 632.

The right-and-left output body part 631 may be positioned on the opposite side of the input plate part 612. For example, the right-and-left output body part 631 may protrude from the back surface of the input plate part 612 and have a hole formed at the center to allow the input shaft part 611 to pass through. The right-and-left output body part 631 may have a disc shape.

A plurality of right-and-left output engagement parts 632 may protrude in the circumferential direction of the right-and-left output body part 631. For example, the right-and-left output engagement part 632 may include a first output surface 691, which is positioned in alignment with the center of the right-and-left output body part 631, and a second output surface 692, which is inclined from the end of the first output surface 691 toward the right-and-left output body part 631. When viewed from the front surface of the rotation input part 61, if the rotation input part 61 rotates clockwise, the first output surface 691 may engage with the right-and-left transmission part 80 to transmit power. Conversely, if the rotation input part 61 rotates counterclockwise, the second output surface 692 may rotate freely without engaging with the right-and-left transmission part 80, thereby blocking power transmission.

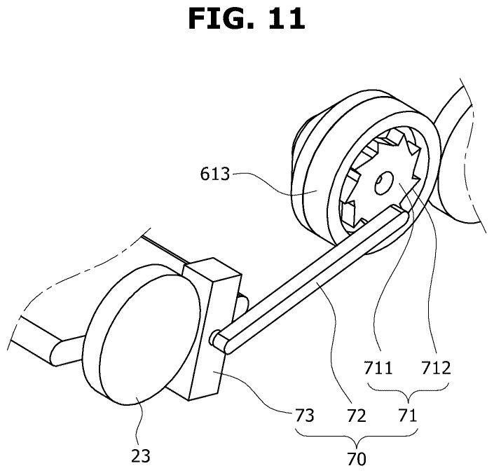

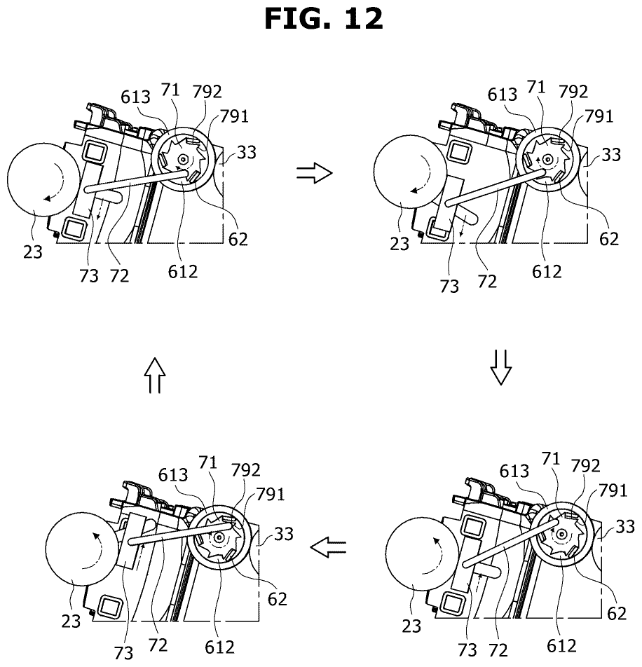

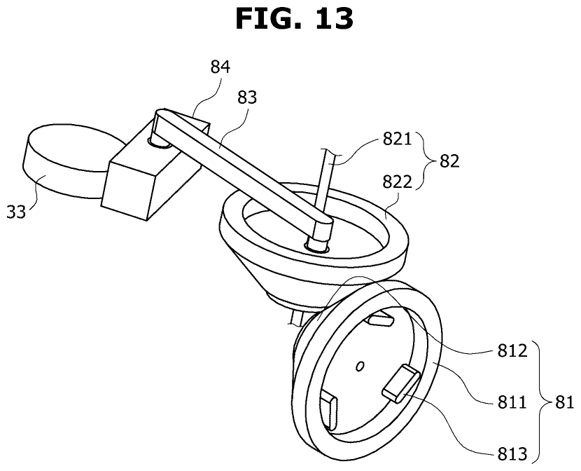

FIG. 11 is a view schematically showing an up-and-down transmission part according to an embodiment of the present disclosure. FIG. 12 is a view schematically showing an operation process of an up-and-down transmission part according to an embodiment of the present disclosure. Referring to FIGS. 11 and 12, the up-and-down transmission part 70 according to an embodiment of the present disclosure may include an up-and-down wheel part 71, an up-and-down link part 72, and an up-and-down reciprocating part 73.

The up-and-down wheel part 71 may rotate in one direction by the power rotation part 60. For example, the up-and-down wheel part 71 may include an up-and-down wheel body part 711 and an up-and-down wheel engagement part 712. The up-and-down wheel part 71 may have a shape corresponding to the right-and-left output part 63. The up-and-down wheel part 71 may be positioned inside the input gear part 613.

The up-and-down wheel body part 711 may be positioned on one side of the input plate part 612. For example, the up-and-down wheel body part 711 may be positioned on the front surface of the input plate part 612 and have a hole formed at the center to allow the input shaft part 611 to pass through. The up-and-down wheel body part 711 may have a disc shape.

A plurality of up-and-down wheel engagement parts 712 may protrude in the circumferential direction of the up-and-down wheel body part 711. For example, the up-and-down wheel engagement part 712 may include a first up-and-down surface 791, which is positioned in alignment with the center of the up-and-down wheel body part 711, and a second up-and-down surface 792, which is inclined from the end of the first up-and-down surface 791 toward the up-and-down wheel body part 711. When viewed from the front surface of the rotation input part 61, if the rotation input part 61 rotates clockwise, the up-and-down output part 62 may engage with the first up-and-down surface 791 to transmit power. Conversely, if the rotation input part 61 rotates counterclockwise, the up-and-down output part 62 may pass over the up-and-down surface 792 and rotate freely without engaging, thereby blocking power transmission.

An end of the up-and-down link part 72 may be connected to the up-and-down wheel part 71. For example, an end of the up-and-down link part 72 may be rotatably coupled to the side edge of the up-and-down wheel body part 711.

The up-and-down reciprocating part 73 may be connected to the opposite end of the up-and-down link part 72 and transmit a rotational force to the up-and-down control unit 20 while moving reciprocally as the up-and-down wheel part 71 rotates. For example, the up-and-down reciprocating part 73 may be guided by the duct part 10 or the housing part 100 to enable linear motion. The opposite end of the up-and-down link part 72 may be rotatably mounted to the up-and-down reciprocating part 73. The up-and-down reciprocating part 73 may remain engaged with the up-and-down gear part 23. As the up-and-down wheel part 71 rotates, and the up-and-down link part 72 pulls or pushes the up-and-down reciprocating part 73, the up-and-down reciprocating part 73 may move reciprocally to provide a rotational force to the up-and-down gear part 23.

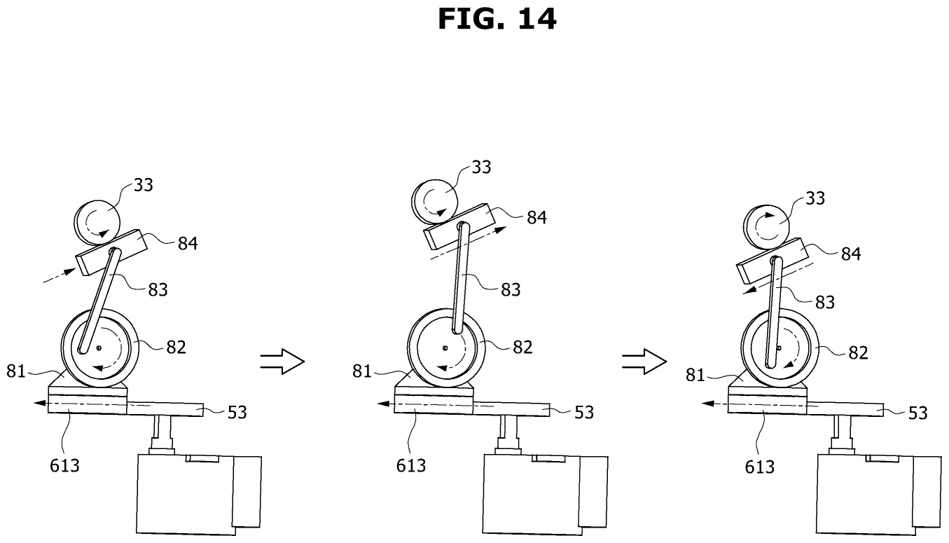

FIG. 13 is a view schematically showing a right-and-left transmission part according to an embodiment of the present disclosure. FIG. 14 is a view schematically showing an operation process of a right-and-left transmission part according to an embodiment of the present disclosure. Referring to FIGS. 13 and 14, the right-and-left transmission part 80 according to an embodiment of the present disclosure may include a right-and-left wheel part 81, a right-and-left gear part 82, a right-and-left link part 83, and a right-and-left reciprocating part 84.

The right-and-left wheel part 81 may rotate in the opposite direction by the power rotation part 60. For example, the right-and-left wheel part 81 may include a first right-and-left wheel part 811 having a ring shape, and a second right-and-left wheel part 812 extending from the first right-and-left wheel part 811 to have a cone shape. The first right-and-left wheel part 811 may be in close contact with or positioned close to the back surface of the input plate part 612. The right-and-left output part 63 may be positioned inside the first right-and-left wheel part 811. Teeth for transmitting power through a bevel gear mechanism may be formed on the outside of the second right-and-left wheel part 812. A third right-and-left wheel part 813 may be formed on the front surface of the second right-and-left wheel part 812. The third right-and-left wheel part 813 may selectively engage with the right-and-left output part 63 to transmit a rotational force. When viewed from an external point toward the up-and-down output part 62, if the right-and-left output part 63 rotates counterclockwise, the first output surface 691 may engage with the third right-and-left wheel part 813 to transmit power. Conversely, if the right-and-left output part 63 rotates clockwise, the second output surface 692 may rotate freely without engaging with the third right-and-left wheel part 813, thereby blocking power transmission. Since the third right-and-left wheel part 813 has a shape and function corresponding to the up-and-down output part 62, a detailed description thereof will be omitted.

The right-and-left gear part 82 may engage with the right-and-left wheel part 81 through the bevel gear mechanism to enable rotation. For example, the right-and-left gear part 82 may include a first right-and-left gear part 821 supported on at least one of the duct part 10 and the housing part 100, and a second right-and-left gear part 822 rotatably mounted to the first right-and-left gear part 821. The first right-and-left gear part 821 may pass through the second right-and-left gear part 822. When the first right-and-left gear part 821 is fixedly installed on the duct part 10 or the housing part 100, the second right-and-left gear part 822 may rotate on the axis of the first right-and-left gear part 821. When the first right-and-left gear part 821 and the second right-and-left gear part 822 remain engaged, the first right-and-left gear part 821 may be rotatably mounted to the duct part 10 or the housing part 100. The second right-and-left gear part 822 may have an inverted cone shape and remain engaged with the second right-and-left wheel part 812.

An end of the right-and-left link part 83 may be connected to the right-and-left gear part 82. For example, an end of the right-and-left link part 83 may be rotatably coupled to the upper edge of the second right-and-left gear part 822.

The right-and-left reciprocating part 84 may be connected to the opposite end of the right-and-left link part 83 and transmit a rotational force to the right-and-left control unit 30 while moving reciprocally as the right-and-left wheel part 81 rotates. For example, the right-and-left reciprocating part 84 may be guided by the duct part 10 or the housing part 100 to enable linear movement. The opposite end of the right-and-left link part 83 may be rotatably mounted to the right-and-left reciprocating part 84. The right-and-left reciprocating part 84 may remain engaged with the right-and-left gear part 33. As the right-and-left gear part 82 rotates, and the right-and-left link part 83 pulls or pushes the right-and-left reciprocating part 84, the right-and-left reciprocating part 84 may move reciprocally to provide a rotational force to the right-and-left gear part 33.

The operation of an electric airflow direction control device having the above-described configuration according to an embodiment of the present disclosure will be described as follows.

The up-and-down control unit 20 and the right-and-left control unit 30 are rotatably mounted to the duct part 10, and the drive unit 40 is connected to the up-and-down control unit 20 and the right-and-left control unit 30.

The up-and-down transmission part 70 is connected to the up-and-down control unit 20, and the right-and-left transmission part 80 is connected to the right-and-left control unit 30. Depending on a rotation direction of the power rotation part 60 that engages with the power supply part 50, either the up-and-down transmission part 70 or the right-and-left transmission part 80 selectively transmits power. Accordingly, depending on a rotation direction provided by a single power supply part 50, either the up-and-down control unit 20 or the right-and-left control unit 30 may operate to change the airflow direction.

Referring to FIGS. 12 and 14, a rotation direction will be described below based on the direction of viewing the input gear part 613 and the right-and-left gear part 82.

When the motor gear part 53 rotates counterclockwise, the rotation input part 61, engaged with the motor gear part 53, rotates clockwise, and the up-and-down wheel part 71, engaged with the up-and-down output part 62, rotates clockwise.

When the up-and-down wheel part 71 rotates clockwise, the up-and-down link part 72, connected to the up-and-down wheel part 71, repeatedly pulls or pushes the up-and-down reciprocating part 73. As a result, the up-and-down reciprocating part 73 moves reciprocally and provides a rotational force to the up-and-down control unit 20, thereby controlling airflow in the up-and-down direction.

In this case, when the rotation input part 61 rotates clockwise, the right-and-left output part 63 does not engage with the right-and-left transmission part 80, thereby blocking power transmission.

When the motor gear part 53 rotates clockwise, the rotation input part 61, engaged with the motor gear part 53, rotates counterclockwise. In this case, the up-and-down output part 62 does not engage with the up-and-down transmission part 70, thereby blocking power transmission.

When the rotation input part 61 rotates counterclockwise, the right-and-left wheel part 81, engaged with the right-and-left output part 63, rotates counterclockwise, and the right-and-left gear part 82, engaged with the right-and-left wheel part 81 through the bevel gear mechanism, rotates. When the right-and-left gear part 82 rotates, the right-and-left link part 83, connected to the right-and-left gear part 82, repeatedly pulls or pushes the right-and-left reciprocating part 84. As a result, the right-and-left reciprocating part 84 moves reciprocally and provides a rotational force to the right-and-left control unit 30, thereby controlling airflow in the right-and-left direction.

The electric airflow direction control device 1 according to an embodiment of the present disclosure may control airflow in the up-and-down direction by transmitting power to the up-and-down control unit 20, or in the right-and-left direction by transmitting power to the right-and-left control unit 30, depending on a rotation direction of the drive unit 40 having a single driving source.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An electric airflow direction control device, comprising:
a duct part configured to guide air;
an up-and-down control unit rotatably mounted to the duct part in an up-and-down direction and configured to control airflow in the up-and-down direction;
a right-and-left control unit rotatably mounted to the duct part in a right-and-left direction and configured to control airflow in the right-and-left direction; and
a drive unit connected to the up-and-down control unit and the right-and-left control unit and configured to selectively provide a rotational force to one of the up-and-down control unit and the right-and-left control unit.

2. The device of claim 1, wherein the up-and-down control unit comprises:
an up-and-down wing part having a first length defined in the right-and-left direction;
an up-and-down shaft part formed on both sides of the up-and-down wing part and configured to be rotatably mounted to the duct part; and
an up-and-down gear part connected to the up-and-down shaft part and connected to the drive unit, the up-and-down gear part being configured to transmit a rotational force.

3. The device of claim 2, wherein the up-and-down control unit further comprises:
an up-and-down linkage part linked with the up-and-down wing part, the up-and-down linkage part being configured to enable rotation.

4. The device of claim 1, wherein the right-and-left control unit comprises:
a right-and-left wing part having a second length defined in the up-and-down direction;
a right-and-left shaft part formed on both sides of the right-and-left wing part and rotatably mounted to the duct part; and
a right-and-left gear part connected to the right-and-left shaft part and connected to the drive unit and configured to transmit a rotational force.

5. The device of claim 4, wherein the right-and-left control unit further comprises:
a right-and-left linkage part linked with the right-and-left wing part, the right-and-left linkage part being configured to enable rotation.

6. The device of claim 1, wherein the drive unit comprises:
a power supply part configured to provide a rotational force in the up-and-down direction and the right-and-left direction;
a power rotation part configured to rotate the up-and-down direction and the right-and-left direction by the power supply part;
an up-and-down transmission part linked with the power rotation part and configured to rotate the up-and-down control unit only when the power rotation part rotates in one direction; and
a right-and-left transmission part linked with the power rotation part and configured to rotate the right-and-left control unit only when the power rotation part rotates in a second direction opposite to the one direction.

7. The device of claim 6, wherein the power supply part comprises:
a motor part configured to be driven when power is applied;
a motor shaft part configured to rotate in the up-and-down direction and the right-and-left direction by driving the motor part; and
a motor gear part mounted to the motor shaft part and configured to engage with the power rotation part.

8. The device of claim 6, wherein the power rotation part comprises:
a rotation input part configured to engage with the power supply part to enable rotation;
an up-and-down output part formed on one side of the rotation input part and configured to selectively engage with the up-and-down transmission part to transmit a rotational force in the one direction; and
a right-and-left output part formed on an opposite side of the rotation input part and configured to selectively engage with the right-and-left transmission part to transmit a rotational force in the second direction.

9. The device of claim 8, wherein the rotation input part comprises:
an input shaft part;
an input plate part configured to rotate, wherein the input shaft part passes through the input plate part; and
an input gear part formed on an edge of the input plate part and configured to engage with the power supply part.

10. The device of claim 9, wherein the up-and-down output part comprises:
an up-and-down output rod part positioned on one side of the input plate part and configured to rotate within a limited rotation angle; and
an up-and-down output restoration part configured to provide a restoring force to the up-and-down output rod part.

11. The device of claim 9, wherein the up-and-down output part comprises:
an up-and-down output fixing part coupled to one of one side of the input plate part and an inner side of the input gear part; and
an up-and-down output extension part configured to extend from the up-and-down output fixing part and having a curved shape that allows a deformation and restoration in the one direction.

12. The device of claim 9, wherein the right-and-left output part comprises:
a right-and-left output body part positioned on an opposite side of the input plate part; and
a plurality of right-and-left output engagement parts configured to protrude in a circumferential direction of the right-and-left output body part.

13. The device of claim 8, wherein each up-and-down output part of a plurality of the up-and-down output parts are spaced apart in a circumferential direction.

14. The device of claim 6, wherein the up-and-down transmission part comprises:
an up-and-down wheel part configured to rotate in a first direction by the power rotation part;
an up-and-down link part comprising a first end connected to the up-and-down wheel part; and
an up-and-down reciprocating part connected to a second end opposite to the first end of the up-and-down link part and configured to transmit a rotational force to the up-and-down control unit while moving reciprocally as the up-and-down wheel part rotates.

15. The device of claim 6, wherein the right-and-left transmission part comprises:
a right-and-left wheel part configured to rotate in the second direction by the power rotation part;
a right-and-left gear part configured to engage with the right-and-left wheel part through a bevel gear mechanism to enable rotation;
a right-and-left link part comprising a first end connected to the right-and-left gear part; and
a right-and-left reciprocating part connected to a second end opposite to the first end of the right-and-left link part and configured to transmit a rotational force to the right-and-left control unit while moving reciprocally as the right-and-left wheel part rotates.
